(19) United States
(12) Patent Application Publication
(10) Pub. No.: US 2019/0073787 A1
(43) Pub. Date: Mar. 7, 2019

(54) COMBINING SPARSE TWO-DIMENSIONAL (2D) AND DENSE THREE-DIMENSIONAL (3D) TRACKING

(71) Applicant: VanGogh Imaging, Inc., McLean, VA (US)

(72) Inventors: Ken Lee, Fairfax, VA (US); Huy Bui, McLean, VA (US); Xin Hou, Herndon, VA (US); Craig Cambias, Silver Spring, MD (US)

(21) Appl. No.: 16/123,256

(22) Filed: Sep. 6, 2018

Related U.S. Application Data
(60) Provisional application No. 62/555,567, filed on Sep. 7, 2017.

(51) Int. Cl. G06T 7/70; G06T 7/20; G06T 11/60

(52) U.S. Cl. CPC G06T 7/70; G06T 7/20; G06T 2207/10024; G06T 2207/10008; G06T 11/60

(57) ABSTRACT

Described are methods and systems for combining sparse two-dimensional (2D) and dense three-dimensional (3D) tracking of objects. A 3D sensor coupled to a computing device captures 3D scans of a physical object, including related pose information, and one or more color images corresponding to each 3D scan. For each 3D scan: the computing device establishes initial sparse 2D correspondences between a current loose frame and one or more of: a last tracked loose frame or a current keyframe. The computing device determines an approximate pose based upon the initial sparse 2D correspondences. The computing device establishes initial dense 3D correspondences between the current loose frame and an anchor frame, and combines the initial sparse 2D correspondences and the initial dense 3D correspondences to generate an estimated pose of the object in the scene.

### RELATED APPLICATIONS

This application claims priority to U.S. Provisional Patent Application No. 62/555,567, filed on Sep. 7, 2017, the entirety of which is incorporated herein by reference.

### TECHNICAL FIELD

This subject matter of this application relates generally to methods and apparatuses, including computer program products, for combining sparse two-dimensional (2D) and dense three-dimensional (3D) tracking of objects in computer vision applications

### BACKGROUND

3D scanners are used increasingly to capture digital models of objects for animation, virtual reality, and e-commerce applications. However, the process for scanning objects to create 3D models is quite challenging, as there may be cases where the objects (and/or scene) consists of both sparse 2D features (e.g., corner points, edges, etc. plus corresponding depth information) and dense 3D features (e.g., geometric information such as shapes plus their corresponding normal information), or only 2D features or 3D features, but not both. Generally, computer vision systems have used either 2D or 3D object tracking schemes depending upon the availability of 3D and/or 2D features in the object. For example, if the computer vision system detects a lot of 3D features in the object/scene, the system can use 3D tracking (as described in U.S. Pat. No. 9,715,761, titled “Real-Time 3D Computer Vision Processing Engine for Object Recognition, Reconstruction, and Analysis” and U.S. patent application Ser. No. 14/849,172, titled “Real-Time Dynamic Three-Dimensional Adaptive Object Recognition and Model Reconstruction,” which are incorporated herein by reference). In another example, if the computer vision system does not detect many 3D features, the system can use 2D features in conjunction with depth information based on sparse tracking (as described in U.S. patent application Ser. No. 15/638,278, titled “Sparse Simultaneous Localization and Matching with Unified Tracking,” filed on Jun. 29, 2017, which is incorporated herein by reference)—which enables the system to obtain pose information of objects based on 2D features.

There may be situations where neither sparse 2D features nor 3D features are strong enough in the object/scene for the computer vision system to generate an accurate pose calculation—and thus the techniques should be combined. However, traditional sparse 2D pose calculation techniques generally have a much different workflow from traditional dense 3D pose calculation techniques.

For example, traditional sparse 2D pose calculation is generally based upon:
a) identifying sparse 2D features in the object/scene;
b) determining sparse 2D correspondences (i.e., relative poses) between the loose frame (i.e., the incoming image+depth image from a sensor, for which the pose is being calculated) and the anchor frame (i.e., the validated map of the current 3D model that is used to find the relative pose of the loose frame); and
c) based upon the set of correspondences, use a Jacobian matrix computation to solve for the pose between the loose and the current map.

In contrast, traditional dense 3D pose calculation is generally based upon an iterative approach:
a) projecting the loose frame onto the anchor frame (based upon the previous pose);
b) calculating error between the loose frame and the anchor frame;
c) moving the position of the loose frame to be closer to the anchor frame; and
d) iterating the previous steps until the error is smaller than an acceptable value.

If the loose frame and anchor frame are well-aligned, then the iteration can stop.

As a result, it is difficult to combine the non-iterative approach of the sparse 2D pose calculation techniques with the iterative approach of the dense 3D pose calculation techniques.

### SUMMARY

Therefore, what is needed are methods and systems that combine sparse 2D pose calculation with dense 3D pose calculation to enable a computer vision system to track an object's pose in a scene accurately in all feature set scenarios (e.g., 2D only, 3D only, 2D+3D. The techniques described herein provide an advantageous process whereby the pose calculation performed by the computer vision system uses a sparse 2D pose calculation approach that is performed iteratively to minimize sparse 2D and dense 3D errors, in order to generate an optimal pose calculation for all three feature set scenarios.

Other aspects and advantages of the technology will become apparent from the following detailed description, taken in conjunction with the accompanying drawings, illustrating the principles of the technology by way of example only.

### BRIEF DESCRIPTION OF THE DRAWINGS

The application file contains at least one drawing executed in color. Copies of this patent or patent application publication with color drawings will be provided by the Office upon request and payment of the necessary fee.

FIG. 1 is a block diagram of a system for generating a three-dimensional (3D) model of an object represented in a scene.

FIG. 2 is a flow diagram of a method of combining sparse 2D object tracking with dense 3D object tracking to generate a pose of an object represented in a scene.

FIG. 3A is an exemplary input image of an object in a scene captured by a 3D sensor, and FIG. 3B depicts the key points on the object as detected by the system.

FIG. 4 depicts the matched key points between a current loose frame and a referenced key frame.

FIG. 5 depicts a 3D model of the object including dense anchor points and current dense points.

### DETAILED DESCRIPTION

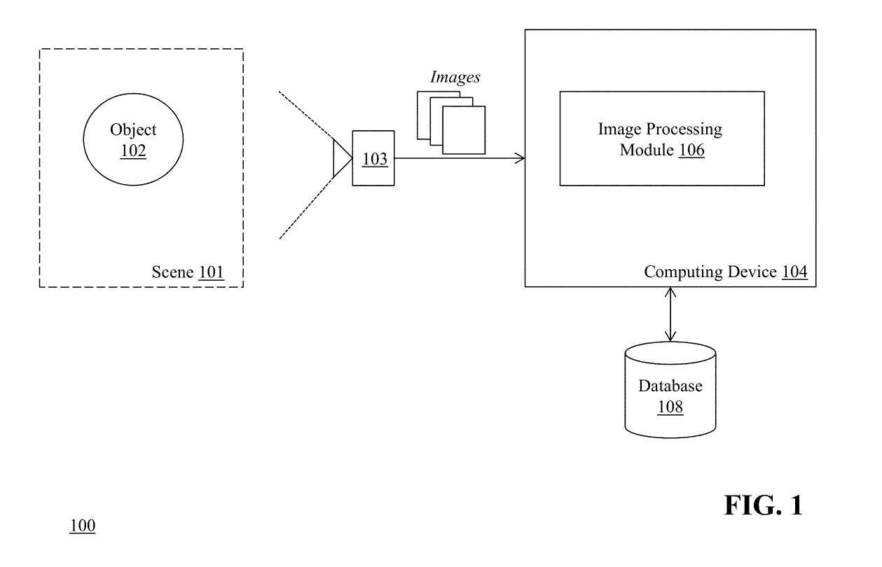

FIG. 1 is a block diagram of a system 100 for generating a three-dimensional (3D) model of an object represented in a scene. Certain embodiments of the systems and methods described in this application utilize the object recognition and modeling techniques as described in U.S. Pat. No. 9,715,761, titled “Real-Time 3D Computer Vision Processing Engine for Object Recognition, Reconstruction, and Analysis” and U.S. patent application Ser. No. 14/849,172, titled “Real-Time Dynamic Three-Dimensional Adaptive Object Recognition and Model Reconstruction,” both of which are incorporated herein by reference. Certain embodiments of the systems and methods described in this application further utilize the 3D photogrammetry techniques as described in U.S. patent application Ser. No. 15/596,590, titled “3D Photogrammetry,” which is also incorporated herein by reference, and the sparse SLAM techniques as described in U.S. patent application Ser. No. 15/638,278, titled “Sparse Simultaneous Localization and Matching with Unified Tracking,” which is further incorporated herein by reference. Such methods and systems are available by implementing the Starry Night plug-in for the Unity 3D development platform, available from VanGogh Imaging, Inc. of McLean, Va.

The system includes a sensor 103 coupled to a computing device 104. The computing device 104 includes an image processing module 106. In some embodiments, the computing device can also be coupled to a data storage module 108, e.g., used for storing certain 3D models, color images, and other data as described herein.

The sensor 103 is positioned to capture images (e.g., color images) of a scene 101 which includes one or more physical objects (e.g., object 102). Exemplary sensors that can be used in the system 100 include, but are not limited to, 3D scanners, digital cameras, and other types of devices that are capable of capturing depth information of the pixels along with the images of a real-world object and/or scene to collect data on its position, location, and appearance. In some embodiments, the sensor 103 is embedded into the computing device 104, such as a camera in a smartphone, for example.

The computing device 104 receives images (also called scans) of the scene 101 from the sensor 103 and processes the images to generate 3D models of objects (e.g., object 102) represented in the scene 101. The computing device 104 can take on many forms, including both mobile and non-mobile forms. Exemplary computing devices include, but are not limited to, a laptop computer, a desktop computer, a tablet computer, a smart phone, augmented reality (AR)/virtual reality (VR) devices (e.g., glasses, headset apparatuses, and so forth), an internet appliance, or the like. It should be appreciated that other computing devices (e.g., an embedded system) can be used without departing from the scope of the invention. The computing device 104 includes network-interface components to connect to a communications network. In some embodiments, the network-interface components include components to connect to a wireless network, such as a Wi-Fi or cellular network, in order to access a wider network, such as the Internet.

The computing device 104 includes an image processing module 106 configured to receive images of the object 102 and scene 101 as captured by the sensor 103 and analyze the images in a variety of ways, including detecting the position and location of objects (e.g., object 102) represented in the images and generating 3D models of objects in the images. The image processing module 106 is a hardware and/or software module that resides on the computing device 104 to perform functions associated with analyzing images capture by the scanner, including the generation of 3D models based upon objects in the images. In some embodiments, the functionality of the image processing module 106 is distributed among a plurality of computing devices. In some embodiments, the image processing module 106 operates in conjunction with other modules that are either also located on the computing device 104 or on other computing devices coupled to the computing device 104. An exemplary image processing module is the Starry Night plug-in for the Unity 3D engine or other similar libraries, available from VanGogh Imaging, Inc. of McLean, Va. It should be appreciated that any number of computing devices, arranged in a variety of architectures, resources, and configurations (e.g., cluster computing, virtual computing, cloud computing) can be used without departing from the scope of the invention.

The data storage module 108 is coupled to the computing device 104, and operates to store data used by the image processing module 106 during its image analysis functions. The data storage module 108 can be integrated with the server computing device 104 or be located on a separate computing device.

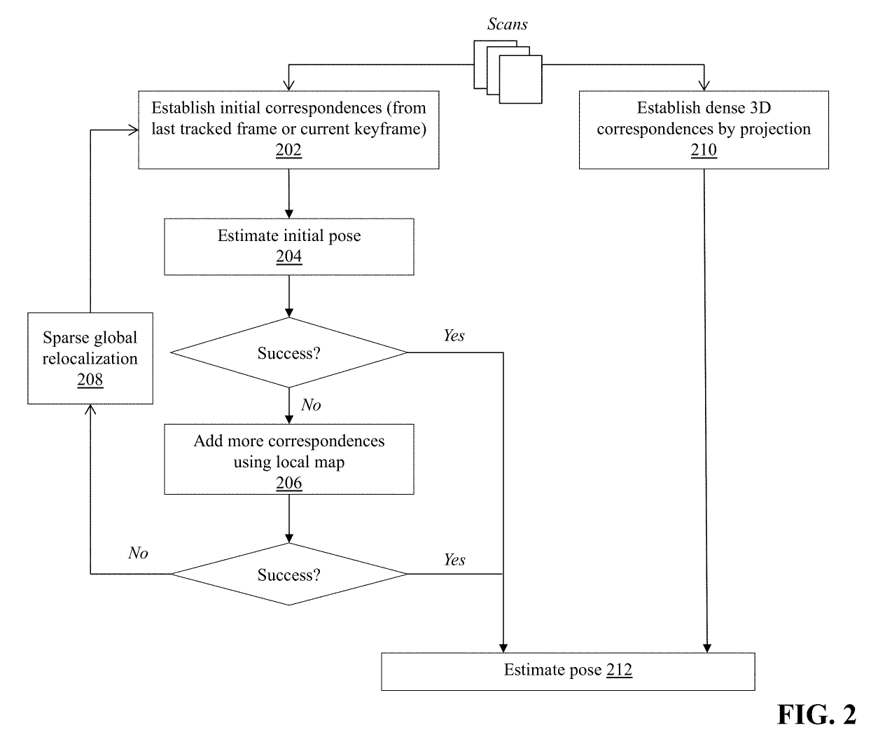

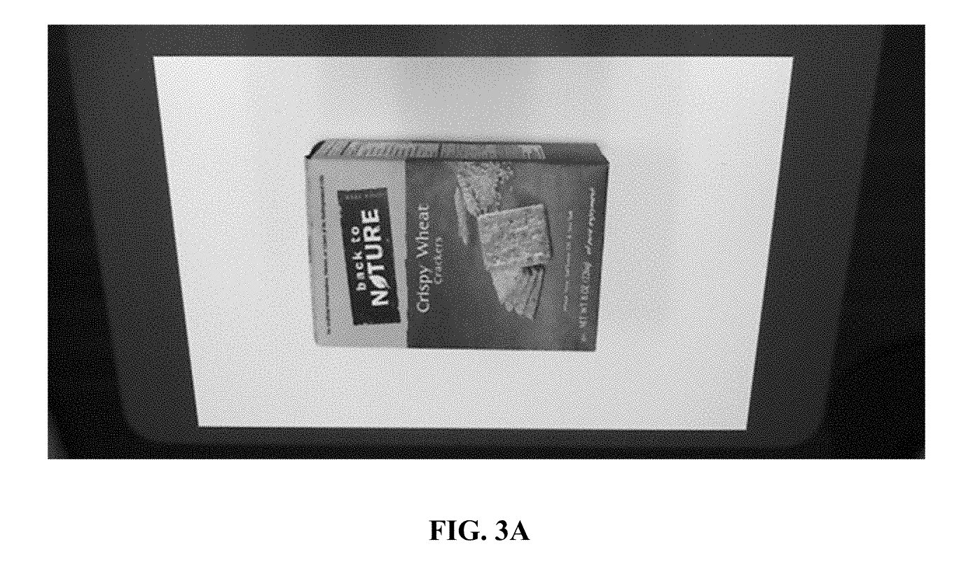

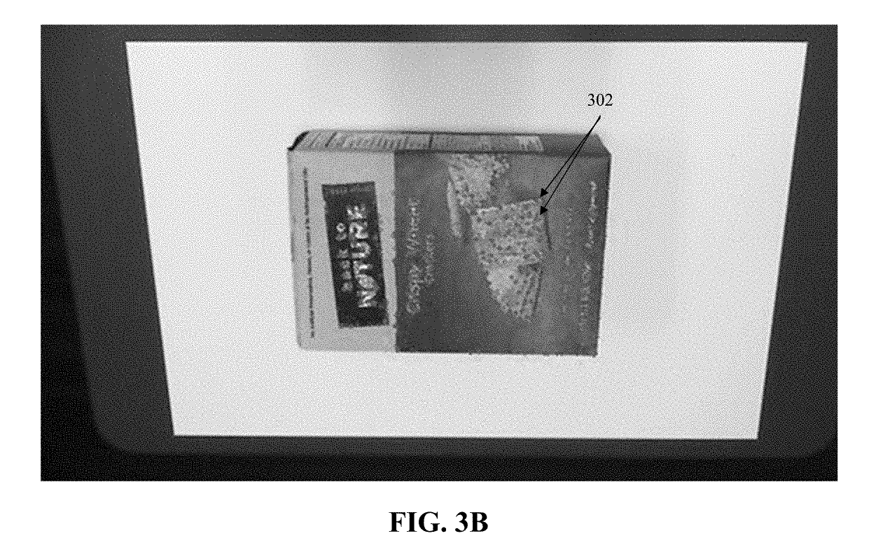

FIG. 2 is a flow diagram of a method of combining sparse 2D object tracking with dense 3D object tracking to generate a pose of an object represented in a scene, using the system 100 of FIG. 1. As shown in FIG. 2, the sensor 103 captures as input one or more 3D scans (e.g., pairs of color-depth (RGB-D) images) of a scene 101 that includes object 102, and corresponding pose information for the object(s) in the scene—see, e.g., FIG. 3A. The sensor 103 transmits the captured scans to the image processing module 106 of computing device 104 for processing as described herein.

The image processing module 106 uses two processing pipelines—one for sparse 2D pose calculation and another for dense 3D pose calculation—for the incoming scans. The sparse 2D pose calculation pipeline is represented in FIG. 2 on the left side, while the dense 3D pose calculation is represented in FIG. 2 on the right side.

In the sparse 2D pose calculation pipeline, the module 106 establishes (202) initial correspondences between the loose frame and the sparse map (which contains key frames and corresponding map points) and estimates (204) an initial pose of the object using the initial correspondences. In this context, the loose frame is a sparse frame computed from the current scan and which contains sparse key points and corresponding feature vectors. The key points are detected by the module 106 based upon features in the input 2D color images, but the key points also have 3D coordinates from the depth image captured by the sensor 103. See FIG. 3B for an example of detected key points (shown in red on the object). The image processing module 106 generates correspondence pairs, which consist of a map point in the object map and a corresponding key point in the loose frame. Each map point has 3D coordinates in the global coordinate system, whereas each key point has 3D coordinates in the current view of the sensor 103.

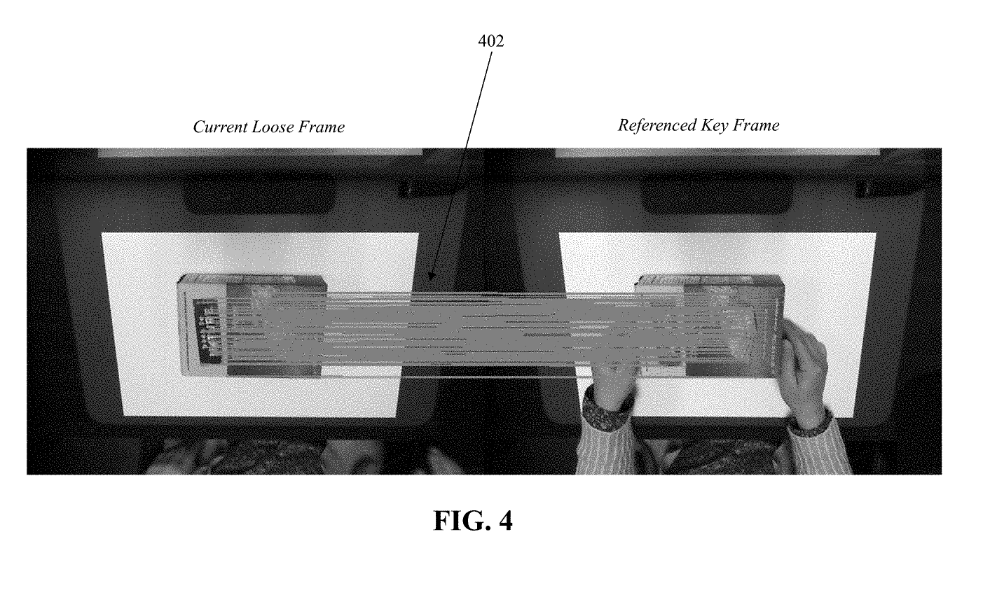

To establish the initial correspondence pairs, the module 106 can project the tracked map points in the last tracked loose frame onto the current loose frame, or the module 106 can project the map points in the current key frame onto the current loose frame. If the module 106 successfully tracked the last loose frame, the module 106 projects the tracked map points in the last loose frame onto the current loose frame using the previously-estimated pose. The module 106 generates the correspondence pairs by finding key points in the current loose frame that are closest to the projected locations. See, e.g., matched key points between a current loose frame (on the left) and a referenced key frame (on the right) in FIG. 4—the green lines represent matched key points. The module 106 estimates (204) an initial pose of the object based upon the generated correspondence pairs. Note that if the module 106 cannot determine an initial pose, then all correspondence pairs are cleared.

If the image processing module 106 did not track the last loose frame, or the previous step did not find the initial pose, then the module 106 uses the current key frame to generate (202) the correspondence pairs. First, the module 106 matches key points in the current key frame against key points in the current loose frame by feature matching. Then, the module 106 establishes correspondences between the map points linked to the key frame and the key points in the current loose frame. After that, the module 106 estimates (204) an initial pose of the object from the correspondence pairs.

The image processing module 106 can also add (206) more correspondence pairs using a local map, in order to estimate the initial pose. In this step, the module 106 tracks the current loose frame against local map points in the local map. The module 106 generates the local map based on the pose estimated in the previous step. Then, the module projects map points in the local map onto the current loose frame to establish correspondence pairs. Map points are persistent key points that have been detected in several key frames. The initial pose of current frame is estimated based on the matching between its key points and the key points in the current key frame. Then, the initial pose is refined by matching key points in current frame against the map points in the local location (the local map). The track local map step 206 makes the pose more accurate compared to only using the key frame, because the key points in the key frame are less stable compared to the map points.

If the above steps both failed to estimate the initial pose, the module 106 runs (208) a sparse global relocalization against the map. In this step, the module 106 finds another key frame from the map to use as a reference key frame and the module 106 generates correspondence pairs between map points in the newly-selected key frame and key points in the current loose frame, as above.

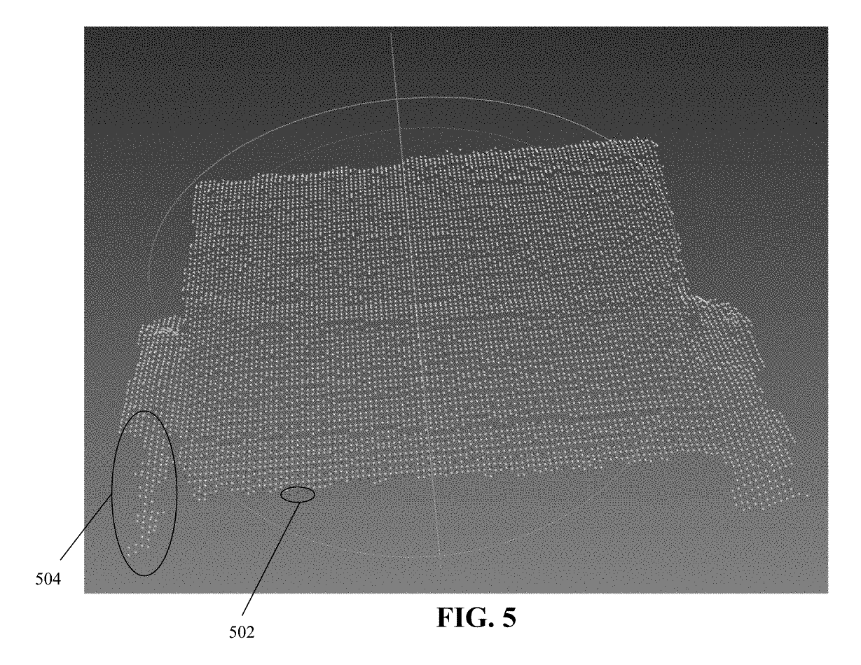

As shown in FIG. 2, the image processing module 106 also executes a dense 3D pose calculation pipeline on the incoming scans to determine a pose of the object in the scene. In the dense 3D pose calculation pipeline, the module 106 establishes (210) dense 3D correspondences between the current dense 3D frame and the anchor frame. The module 106 generates the anchor frame by raycasting the global 3D truncated signed distance function (TSDF) volume using the previous pose. The anchor points are in the global coordinate system. See FIG. 5 for an example showing dense anchor points (in red) and current dense points (in green).

To establish dense correspondences, first the module 106 transforms the anchor frame to the current view, using the pose of the previous frame. Then, the module 106 projects each 3D point in the current frame onto the anchor frame, which is organized as a dense array. The module 106 selects the anchor point closest to the projected location as the correspondence of the point in the current frame. The module 106 incorporates outlier rejection by restricting the distance between the current point and the anchor point, as well as the difference between their normal vectors.

Once the image processing module 106 has generated 2D correspondences in the 2D pipeline and generated 3D correspondences in the 3D pipeline, the module 106 uses both 2D and 3D correspondences to estimate the current pose of the object 102 in the scene 101, as described below. It should be appreciated that this process is iterative between re-establishing dense correspondences and re-estimating a new pose.

Let (R, T) be the pose of the current frame, which brings the current frame to the global coordinate system.

Let {pᵢ^{(s)}}_{i=1 . . . N}_{ₛ} be the be the key points in the current frame and let {qᵢ^{(s)}}_{i=1 . . . N}_{ₛ} be the corresponding map point.

The sparse cost function is:

$${J}_{sparse} ( R , T ) = {\sum }_{i = 1}^{{N}_{s}} {‖ {Rp}_{i}^{( s )} + T - {q}_{i}^{( s )} ‖}^{2}$$

Let {pᵢ^{(d)}, n_{q}_{ᵢ}^{(d)}}_{i=1 . . . N}_{_{d}} be the dense points in current frame with their corresponding surface normals.

Let {qᵢ^{(d)}, n_{q}_{ᵢ}^{(d)}}_{i=1 . . . N}_{_{d}} be the corresponding anchor points and normal vectors.

The dense cost function based on point-to-plane distance is:

$${J}_{dense} ( R , T ) = {\sum }_{i = 1}^{{N}_{d}} {‖ {n}_{{q}_{i}}^{{( d )}^{T}} ( {Rp}_{i}^{( s )} + T - {q}_{i}^{( d )} ) ‖}^{2}$$

The combined cost function is defined as:

J(R,T)=wₛₚₐᵣₛₑJₛₚₐᵣₛₑ(R,T)+w_{dense}J_{dense}(R,T),

where wₛₚₐᵣₛₑ and w_{dense} are the weights for the sparse cost and the dense cost, respectively.

The image processing module 106 obtains the pose of the current frame by minimizing the above cost function. To minimize the cost function, the module 106 linearizes the cost function using small angle approximation. This is done by estimating the delta pose between current frame and the last frame instead of directly estimating the global pose of current frame, as follows:

Let (Rₚᵣₑᵥ, Tₚᵣₑᵥ): be the pose (rotation matrix and translation vector) of the last frame, and (ΔR, ΔT) be the estimated delta transform to bring the current frame to the last frame.

The module 106 initializes several values:
Set (ΔR, ΔT) to identity transform: ΔR=I, ΔT=0
Transform {qᵢ^{(s)}}_{i=1 . . . N}_{ₛ} and {qᵢ^{(d)}, n_{q}_{ᵢ}^{(d)}}_{i=1 . . . N}_{_{d}} to current view using the inverse of (Rₚᵣₑᵥ, Tₚᵣₑᵥ):

\hat{q}=(Rₚᵣₑᵥ)⁻¹q−(Rₚᵣₑᵥ)⁻¹Tₚᵣₑᵥ

The module 106 then iterates:
Transform {pᵢ^{(s)}}_{i=1 . . . N}_{ₛ} and {pᵢ^{(d)}, n_{q}_{ᵢ}^{(d)}}_{i=1 . . . N}_{_{d}} using (ΔR, ΔT):

\hat{p}=ΔRp+ΔT
Re-establish dense correspondences and compute dense equation.
Reject sparse outliers and compute sparse equation.
Combine the dense equation and the sparse equation and solve for the update (R_{update}, T_{update})
Update delta pose:

ΔR=R_{update}ΔR

ΔT=R_{update}ΔT+T_{update}
Check for convergence. If convergence condition is not satisfied, return to step a.

As described above, the dense 3D correspondences comprise two levels, coarse and fine. The image processing module 106 runs the cost function minimization algorithm with the coarse level first to obtain an initial pose, which is then refined using the fine level. As a result, the number of iterations of the algorithm is reduced on the fine level and speeds up the overall process.

As described above, the sparse outlier removal is based upon matching error. For each iteration, the module 106 reduces the error threshold and matching pairs with distance greater than the threshold are marked as outliers, and these outliers are not used to construct the equation. For the first iteration, matching sparse pairs with an error within the top 10% are marked as outliers.

As described above, the module 106 uses equal weights for sparse and dense correspondences. The weighting scheme can be refined to balance the contribution of sparse and dense correspondence to the final pose.

It should be appreciated that the methods, systems, and techniques described herein are applicable to a wide variety of useful commercial and/or technical applications. Such applications can include, but are not limited to:
Augmented Reality/Virtual Reality, Robotics, Education, Part Inspection, E-Commerce, Social Media, Internet of Things—to capture, track, and interact with real-world objects from a scene for representation in a virtual environment, such as remote interaction with objects and/or scenes by a viewing device in another location, including any applications where there may be constraints on file size and transmission speed but a high-definition image is still capable of being rendered on the viewing device;
Live Streaming—for example, in order to live stream a 3D scene such as a sports event, a concert, a live presentation, and the like, the techniques described herein can be used to immediately send out a sparse frame to the viewing device at the remote location. As the 3D model becomes more complete, the techniques provide for adding full texture. This is similar to video applications that display a low-resolution image first while the applications download a high-definition image. Furthermore, the techniques can leverage 3D model compression to further reduce the geometric complexity and provide a seamless streaming experience;
Recording for Later ‘Replay’—the techniques can advantageously be used to store images and relative pose information (as described above) in order to replay the scene and objects at a later time. For example, the computing device can store 3D models, image data, pose data, and sparse feature point data associated with the sensor capturing, e.g., a video of the scene and objects in the scene. Then, the viewing device 112 can later receive this information and recreate the entire video using the models, images, pose data and feature point data.

The above-described techniques can be implemented in digital and/or analog electronic circuitry, or in computer hardware, firmware, software, or in combinations of them. The implementation can be as a computer program product, i.e., a computer program tangibly embodied in a machine-readable storage device, for execution by, or to control the operation of, a data processing apparatus, e.g., a programmable processor, a computer, and/or multiple computers. A computer program can be written in any form of computer or programming language, including source code, compiled code, interpreted code and/or machine code, and the computer program can be deployed in any form, including as a stand-alone program or as a subroutine, element, or other unit suitable for use in a computing environment. A computer program can be deployed to be executed on one computer or on multiple computers at one or more sites.

Method steps can be performed by one or more specialized processors executing a computer program to perform functions by operating on input data and/or generating output data. Method steps can also be performed by, and an apparatus can be implemented as, special purpose logic circuitry, e.g., a FPGA (field programmable gate array), a FPAA (field-programmable analog array), a CPLD (complex programmable logic device), a PSoC (Programmable System-on-Chip), ASIP (application-specific instruction-set processor), or an ASIC (application-specific integrated circuit), or the like. Subroutines can refer to portions of the stored computer program and/or the processor, and/or the special circuitry that implement one or more functions.

Processors suitable for the execution of a computer program include, by way of example, special purpose microprocessors. Generally, a processor receives instructions and data from a read-only memory or a random access memory or both. The essential elements of a computer are a processor for executing instructions and one or more memory devices for storing instructions and/or data. Memory devices, such as a cache, can be used to temporarily store data. Memory devices can also be used for long-term data storage. Generally, a computer also includes, or is operatively coupled to receive data from or transfer data to, or both, one or more mass storage devices for storing data, e.g., magnetic, magneto-optical disks, or optical disks. A computer can also be operatively coupled to a communications network in order to receive instructions and/or data from the network and/or to transfer instructions and/or data to the network. Computer-readable storage mediums suitable for embodying computer program instructions and data include all forms of volatile and non-volatile memory, including by way of example semiconductor memory devices, e.g., DRAM, SRAM, EPROM, EEPROM, and flash memory devices; magnetic disks, e.g., internal hard disks or removable disks; magneto-optical disks; and optical disks, e.g., CD, DVD, HD-DVD, and Blu-ray disks. The processor and the memory can be supplemented by and/or incorporated in special purpose logic circuitry.

To provide for interaction with a user, the above described techniques can be implemented on a computer in communication with a display device, e.g., a CRT (cathode ray tube), plasma, or LCD (liquid crystal display) monitor, for displaying information to the user and a keyboard and a pointing device, e.g., a mouse, a trackball, a touchpad, or a motion sensor, by which the user can provide input to the computer (e.g., interact with a user interface element). Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, and/or tactile input.

The above described techniques can be implemented in a distributed computing system that includes a back-end component. The back-end component can, for example, be a data server, a middleware component, and/or an application server. The above described techniques can be implemented in a distributed computing system that includes a front-end component. The front-end component can, for example, be a client computer having a graphical user interface, a Web browser through which a user can interact with an example implementation, and/or other graphical user interfaces for a transmitting device. The above described techniques can be implemented in a distributed computing system that includes any combination of such back-end, middleware, or front-end components.

The components of the computing system can be interconnected by transmission medium, which can include any form or medium of digital or analog data communication (e.g., a communication network). Transmission medium can include one or more packet-based networks and/or one or more circuit-based networks in any configuration. Packet-based networks can include, for example, the Internet, a carrier internet protocol (IP) network (e.g., local area network (LAN), wide area network (WAN), campus area network (CAN), metropolitan area network (MAN), home area network (HAN)), a private IP network, an IP private branch exchange (IPBX), a wireless network (e.g., radio access network (RAN), Bluetooth, Wi-Fi, WiMAX, general packet radio service (GPRS) network, HiperLAN), and/or other packet-based networks. Circuit-based networks can include, for example, the public switched telephone network (PSTN), a legacy private branch exchange (PBX), a wireless network (e.g., RAN, code-division multiple access (CDMA) network, time division multiple access (TDMA) network, global system for mobile communications (GSM) network), and/or other circuit-based networks.

Information transfer over transmission medium can be based on one or more communication protocols. Communication protocols can include, for example, Ethernet protocol, Internet Protocol (IP), Voice over IP (VOIP), a Peer-to-Peer (P2P) protocol, Hypertext Transfer Protocol (HTTP), Session Initiation Protocol (SIP), H.323, Media Gateway Control Protocol (MGCP), Signaling System #7 (SS7), a Global System for Mobile Communications (GSM) protocol, a Push-to-Talk (PTT) protocol, a PTT over Cellular (POC) protocol, Universal Mobile Telecommunications System (UMTS), 3GPP Long Term Evolution (LTE) and/or other communication protocols.

Devices of the computing system can include, for example, a computer, a computer with a browser device, a telephone, an IP phone, a mobile device (e.g., cellular phone, personal digital assistant (PDA) device, smart phone, tablet, laptop computer, electronic mail device), and/or other communication devices. The browser device includes, for example, a computer (e.g., desktop computer and/or laptop computer) with a World Wide Web browser (e.g., Chrome™ from Google, Inc., Microsoft® Internet Explorer® available from Microsoft Corporation, and/or Mozilla® Firefox available from Mozilla Corporation). Mobile computing device include, for example, a Blackberry® from Research in Motion, an iPhone® from Apple Corporation, and/or an Android™-based device. IP phones include, for example, a Cisco® Unified IP Phone 7985G and/or a Cisco® Unified Wireless Phone 7920 available from Cisco Systems, Inc.

Comprise, include, and/or plural forms of each are open ended and include the listed parts and can include additional parts that are not listed. And/or is open ended and includes one or more of the listed parts and combinations of the listed parts.

One skilled in the art will realize the technology may be embodied in other specific forms without departing from the spirit or essential characteristics thereof. The foregoing embodiments are therefore to be considered in all respects illustrative rather than limiting of the technology described herein.

What is claimed is:

1. A computerized method of combining sparse two-dimensional (2D) and dense three-dimensional (3D) tracking of objects, the method comprising:
capturing, by a 3D sensor coupled to a computing device, one or more 3D scans of a physical object to be tracked, including related pose information of the physical object, and one or more color images corresponding to each 3D scan;
for each 3D scan:
establishing initial sparse 2D correspondences between a current loose frame and one or more of: a last tracked loose frame or a current keyframe;
determining an approximate pose based upon the initial sparse 2D correspondences;
establishing initial dense 3D correspondences between the current loose frame and an anchor frame; and
combining the initial sparse 2D correspondences and the initial dense 3D correspondences to generate an estimated pose of the object in the scene.

2. A system for combining sparse two-dimensional (2D) and dense three-dimensional (3D) tracking of objects, the system comprising:
a 3D sensor that captures one or more 3D scans of a physical object to be tracked, including related pose information of the physical object, and one or more color images corresponding to each 3D scan;
for each 3D scan:
a computing device coupled to the 3D sensor that:
establishes initial sparse 2D correspondences between a current loose frame and one or more of: a last tracked loose frame or a current keyframe;
determines an approximate pose based upon the initial sparse 2D correspondences;
establishes initial dense 3D correspondences between the current loose frame and an anchor frame; and
combines the initial sparse 2D correspondences and the initial dense 3D correspondences to generate an estimated pose of the object in the scene.
